(19) United States
(12) Patent Application Publication
(10) Pub. No.: US 2021/0086140 A1
(43) Pub. Date: Mar. 25, 2021

(54) SOLUTION FOR MANUFACTURING MEMBRANE AND METHOD FOR MANUFACTURING SEPARATION MEMBRANE USING SAME

(71) Applicants: DAICEL CORPORATION, Osaka-shi, Osaka (JP); NATIONAL UNIVERSITY CORPORATION KOBE UNIVERSITY, Kobe-shi, Hyogo (JP)

(72) Inventors: Hideto MATSUYAMA, Kobe-shi, Hyogo (JP); Sungil JEON, Kobe-shi, Hyogo (JP); Shota TAKAO, Tokyo (JP); Toyozo HAMADA, Tokyo (JP)

(73) Assignees: DAICEL CORPORATION, Osaka-shi, Osaka (JP); NATIONAL UNIVERSITY CORPORATION KOBE UNIVERSITY, Kobe-shi, Hyogo (JP)

(21) Appl. No.: 16/633,903

(22) PCT Filed: Jul. 24, 2018
(86) PCT No.: PCT/JP2018/027614

§ 371 Date: Jan. 24, 2020

(30) Foreign Application Priority Data
Jul. 25, 2017 (JP) 2017-143196

(51) Int. Cl. B01D 69/08; B01D 69/02

(52) U.S. Cl. CPC B01D 69/087; B01D 69/10; B01D 69/02

(57) ABSTRACT

Providing a membrane-forming solution suitable for producing a separation membrane such as a hollow fiber membrane and a flat membrane. A membrane-forming solution including triacetylcellulose having an acetyl group substitution degree of 2.7 or higher, a good solvent for thermally induced phase separation and a poor solvent for thermally induced phase separation, wherein the good solvent is capable of heat-dissolving the triacetylcellulose (at a solid content concentration of 25 mass %), and the poor solvent is incapable of dissolving the triacetylcellulose up to the heat dissolution temperature of the good solvent, wherein both the good solvent and the poor solvent are included so as to enable phase separation of the heat-dissolved triacetylcellulose solution while the heat-dissolved triacetylcellulose solution is cooled to room temperature (from 20 to 30° C.), and wherein a mixing ratio in a total amount of the good solvent and the poor solvent is from 5 to 40 mass % of the good solvent and from 60 to 95 mass % of the poor solvent.

### TECHNICAL FIELD

The present invention relates to a membrane-forming solution for producing a hollow fiber membrane and a flat membrane, and a method for producing a separation membrane using the same.

### BACKGROUND ART

Separation membranes using a membrane, such as a hollow fiber membrane or a flat membrane, are widely used in various technical fields, and many membrane materials, such as hydrophilic or hydrophobic materials, are also known. Among them, separation membranes made of cellulose acetate as a membrane material are excellent in hydrophilicity, resistant to chlorine, and biodegradable, and thus those are quite excellent as separation membranes.

Chinese Patent No. 102824859 (CN 102824859 B) describes an invention of a method for producing a hollow fiber nanofiltration membrane including cellulose acetate as one of membrane materials. Chinese Patent No. 103831023 (CN 103831023 B) describes an invention of a method for producing a cellulose acetate hollow fiber nanofiltration membrane.

CN 103831023 B describes, as high-temperature solvents for a thermally induced phase separation method (TIPS method), methyl salicylate, ethyl salicylate, methyl benzoate, ethyl benzoate, diphenyl carbonate, diethylene glycol monoethyl ether acetate, γ-butyrolactone, ethylene carbonate, phenylacetone, benzophenone, diethylene glycol, triethylene glycol, tetraethylene glycol, 2-methyl-2,4-pentanediol, 2-ethyl-1,3-hexanediol, 1,2-propanediol, 1,3-propanediol, benzyl alcohol, dimethyl phthalate, diethyl phthalate, and dibutyl phthalate. These high-temperature solvents cannot be used as a solvent for the thermally induced phase separation method (TIPS method) of triacetylcellulose having an acetyl group substitution degree of 2.7 or higher.

For Kagaku Kogaku Ronbunshu (Chemical Engineering Paper Collection), Vol. 35 (2009) No. 1, p. 117-121 (Effect of Amphiphilic Additives on Membrane Properties of Cellulose Acetate Derivative Hollow Fiber Membrane Prepared by Thermally Induced Phase Separation Method), a hollow fiber membrane is prepared by a thermally induced phase separation method (TIPS method) using, as a membrane material, cellulose acetate butyrate formed by partially modifying cellulose acetate with a butyryl group.

### SUMMARY OF INVENTION

An object of the present invention is to provide a membrane-forming solution capable of forming a membrane by a thermally induced phase separation method, and a method for producing a separation membrane using the same.

The present invention provides: a membrane-forming solution including triacetylcellulose having an acetyl group substitution degree of 2.7 or higher and a good solvent for thermally induced phase separation, wherein the good solvent is capable of heat-dissolving the triacetylcellulose at a solid content concentration of 25 mass % and is capable of phase-separating the heat-dissolved triacetylcellulose solution while the heat-dissolved triacetylcellulose solution is cooled to room temperature (20 to 30° C.), and a method for producing a separation membrane using the membrane-forming solution.

In addition, the present invention provides: a membrane-forming solution including triacetylcellulose having an acetyl group substitution degree of 2.7 or higher, a good solvent for thermally induced phase separation and a poor solvent for thermally induced phase separation, wherein the good solvent is capable of heat-dissolving the triacetylcellulose at a solid content concentration of 25 mass %, and the poor solvent is incapable of dissolving the triacetylcellulose at a solid content concentration of 25 mass % at 160° C., both the good solvent and the poor solvent are included to enable phase separation of the heat-dissolved triacetylcellulose solution while the heat-dissolved triacetylcellulose solution is cooled to room temperature (from 20 to 30° C.); and a mixing ratio in a total amount of the good solvent and the poor solvent is from 5 to 40 mass % of the good solvent and from 60 to 95 mass % of the poor solvent; and a method for producing a separation membrane using the membrane-forming solution.

The thermally induced phase separation method using the membrane-forming solution according to an embodiment of the present invention can provide a liquid separation membrane and a gas separation membrane of triacetylcellulose having an acetyl group substitution degree of 2.7 or higher, and a support membrane or a separation functional membrane that constitutes the liquid separation membrane or the gas separation membrane, where these membranes have high strength, high permeability, high blocking performance and excellent antifouling performance.

### BRIEF DESCRIPTION OF DRAWINGS

FIG. 1 is a conceptual diagram of a manufacturing apparatus for a hollow fiber membrane used in Examples.

FIG. 2A is a scanning electron microscope (SEM) photograph (×60) of a radial cross-section of a hollow fiber membrane obtained in Example 1, FIG. 2B is an enlarged SEM photograph (×50000) of the outer surface side of FIG. 2A, and FIG. 2C is an enlarged SEM photograph (×50000) of the inner surface side of FIG. 2A.

FIG. 3A is a scanning electron microscope (SEM) photograph (×60) of a radial cross-section of a hollow fiber membrane obtained in Comparative Example 1, FIG. 3B is an enlarged SEM photograph (×50000) of the outer surface side of FIG. 3A, and FIG. 3C is an enlarged SEM photograph (×50000) of the inner surface side of FIG. 3A.

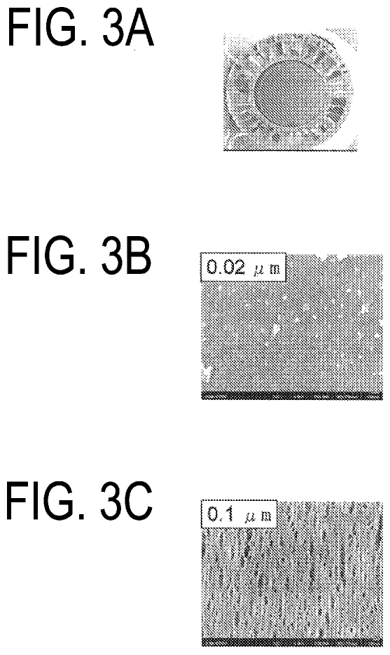

### DESCRIPTION OF EMBODIMENTS

### First Membrane-Forming Solution

A first membrane-forming solution according to an embodiment of the present invention is a membrane-forming solution including triacetylcellulose having an acetyl group substitution degree of 2.7 or higher and a good solvent for thermally induced phase separation, and the membrane-forming solution does not include a poor solvent.

The good solvent is capable of heat-dissolving the triacetylcellulose at a solid content concentration of 25 mass % when the good solvent and the triacetylcellulose are mixed, and is capable of phase-separating the triacetylcellulose solution while the triacetylcellulose solution is cooled to room temperature from 20 to 30° C.

The good solvent is preferably one or more selected from 1,3-butanediol, 1,4-butanediol, 1,2-butanediol, 2,3-butanediol and 2,2-dimethyl-1,3-propanediol.

A heat dissolution temperature varies depending on the kinds of good solvents and is preferably in a range from 150 to 220° C. In a case where 1,3-butanediol is used as a good solvent to dissolve the triacetylcellulose to obtain a membrane-forming solution, the solvent is preferably heated to at least 190° C. (from 190° C. to 220° C.), and in a case where 2,2-dimethyl-1,3-propanediol is used as a good solvent to dissolve the triacetylcellulose to obtain a membrane-forming solution, the solvent is preferably heated to at least 170° C. (from 170° C. to 220° C.).

### Second Membrane-Forming Solution

A second membrane-forming solution according to an embodiment of the present invention is a membrane-forming solution including triacetylcellulose having an acetyl group substitution degree of 2.7 or higher, a good solvent for thermally induced phase separation and a poor solvent for thermally induced phase separation.

The good solvent is capable of heat-dissolving the triacetylcellulose at a solid content concentration of 25 mass % when the good solvent and the triacetylcellulose are mixed.

The poor solvent is incapable of dissolving the triacetylcellulose at a solid content concentration of 25 mass % when the poor solvent and the triacetylcellulose are mixed at 160° C. or lower.

By including both the good solvent and the poor solvent, the good solvent and the poor solvent are capable of phase-separating the heat-dissolved triacetylcellulose solution while the heat-dissolved triacetylcellulose solution is cooled to room temperature from 20 to 30° C.

Examples of the good solvent include one or more selected from sulfolane, dimethyl sulfoxide (DMSO), tetramethyl urea, tetrahydrofurfuryl alcohol, N-ethyl toluene sulfonamide, triethyl phosphate, trimethyl phosphate and dimethyl succinate.

Examples of the poor solvent include one or more selected from 1,3-butanediol, 1,4-butanediol, 1,2-butanediol, 2,3-butanediol, 2,2-dimethyl-1,3-propanediol, 1,5-pentanediol, 1,6-hexanediol, 3-methyl-1,5-pentanediol, triethylene glycol, 2,5-dimethyl-2,5-hexanediol, dipropylene glycol, diethyl maleate, tetraethylene glycol, 2-methyl-2,4-pentanediol, propylene glycol diacetate, glycerol triacetate(triacetin), dipropylene glycol methyl ether, diethylene glycol monobutyl ether, 1,4-butanediol diacetate, 2-ethyl-1,3-hexanediol, 1,3-butylene glycol diacetate, dipropylene glycol n-propyl ether, tripropylene glycol, di-n-butyl phthalate, dipropylene glycol n-butyl ether, tripropylene glycol methyl ether, α-terpineol, dimethyl phthalate, lactate ethyl acetate, di-n-butyl fumarate, methanol, di-n-butyl sebacate, diethylene glycol monoacetate, dipropylene glycol methyl ether acetate, terpinyl acetate, dihydroterpinyl acetate, tripropylene glycol-methyl-n-propyl ether, dipropylene glycol-methyl-n-isopentyl ether, dipropylene glycol-methyl-n-propyl ether, diallyl phthalate, diethyl phthalate, bis(2-methoxyethyl) phthalate, dimethyl adipate, diethyl adipate, tributyl phosphate, triethyl citrate, triethyl o-acetyl citrate, diethyl succinate, bis(2-ethylhexyl) sebacate, diethyl fumarate and diisobutyl fumarate.

The good solvent and the poor solvent are combined in consideration that the combination is capable of heat-dissolving the triacetylcellulose (at a solid content concentration of 25 mass % when the good solvent, the poor solvent and the triacetylcellulose are mixed) in a range from 150 to 220° C. and phase-separating the heat-dissolved triacetylcellulose solution while the heat-dissolved triacetylcellulose solution is cooled to room temperature (from 20 to 30° C.).

In addition, 1,3-butanediol or 2,2-dimethyl-1,3-propanediol, which can be used as a good solvent in the first membrane-forming solution, can be used as a poor solvent.

When used as a poor solvent, 1,3-butanediol is combined with a good solvent capable of heat-dissolving the triacetylcellulose at a temperature lower than 190° C., preferably 180° C. or lower (for example, sulfolane). When used as a poor solvent, 2,2-dimethyl-1,3-propanediol is combined with a good solvent capable of heat-dissolving the triacetylcellulose at a temperature lower than 170° C., preferably 160° C. or lower (for example, sulfolane).

The mixing ratio in a total amount of the good solvent and the poor solvent is preferably from 5 to 40 mass % of the good solvent and from 60 to 95 mass % of the poor solvent, more preferably from 10 to 30 mass % of the good solvent and from 70 to 90 mass % of the poor solvent, and even more preferably from 15 to 25 mass % of the good solvent and from 75 to 85% mass % of the poor solvent.

### Method for Producing First Separation Membrane

The method for producing a separation membrane according to an embodiment of the present invention is a production method involving a thermally induced phase separation method using the first membrane-forming solution described above to obtain a separation membrane.

In a first step, triacetylcellulose and the good solvent are mixed and heat-dissolved to obtain the first membrane-forming solution. A heat dissolution temperature is a temperature at which the good solvent to be used is capable of heat-dissolving the triacetylcellulose (at a solid content concentration of 25 mass % when the good solvent and the triacetylcellulose are mixed) and is preferably in a range from 150 to 220° C.

Next, in a second step, while the first membrane-forming solution in a heated state obtained in the first step is cooled to room temperature (from 20 to 30° C.), the first membrane-forming solution is phase-separated to form a separation membrane. In a case where the separation membrane is a hollow fiber membrane, the method described in Examples can be applied, in which a poor solvent can be used as an internal coagulation liquid (core liquid), and a poor solvent or water can be used as an external coagulation liquid. In a case where the separation membrane is a flat membrane, such a method that the first membrane-forming solution is discharged in the shape of a flat membrane from above the liquid surface of a coagulation liquid (poor solvent or water) to beneath the surface to cool the first membrane-forming solution can be applied.

Next, in a third step, the separation membrane is washed to remove the good solvent and the target separation membrane is obtained.

The separation membrane obtained by the method for producing the first separation membrane does not include macrovoid structure, but includes a uniform sponge structure with an average pore diameter from 0.01 μm to 1 μm. In an embodiment of the present invention, the macrovoid structure refers to such a structure that includes voids with a pore diameter of 20 μm or greater in the separation membrane.

### Method for Producing Second Separation Membrane

The method for producing a separation membrane according to an embodiment of the present invention is a production method involving a thermally induced phase separation method using the second membrane-forming solution described above to obtain the separation membrane.

In a first step, triacetylcellulose, the good solvent, and the poor solvent are mixed and heat-dissolved to obtain the second membrane-forming solution. A heat dissolution temperature is a temperature at which the good solvent and the poor solvent to be used in a mixed state are capable of heat-dissolving the triacetylcellulose (solid concentration of 25 mass % when the good solvent, the poor solvent and the triacetylcellulose are mixed) and is preferably in a range from 150 to 220° C.

Next, in a second step, while the second membrane-forming solution in a heated state obtained in the first step is cooled to room temperature (from 20 to 30° C.), the second membrane-forming solution is phase-separated to form a separation membrane. The second step can be performed in the same manner as the second step of the method for producing the first separation membrane.

Next, in a third step, the separation membrane is washed to remove the good solvent and the poor solvent, and the target separation membrane is obtained. The separation membrane obtained by the method for producing the second separation membrane does not include macrovoid structure, but includes a uniform sponge structure with an average pore diameter size from 0.01 μm to 1 μm.

In a case where the separation membrane obtained by the method for producing the first separation membrane and the method for producing the second separation membrane according to an embodiment of the present invention is a hollow fiber membrane for liquid separation, the pure water permeation rate of the hollow fiber membrane is preferably from 10 to 3000 L/(m²·h·0.1 MPa), and in a case where the membrane is a hollow fiber membrane or a hollow fiber support membrane for gas separation, the pure water permeation rate is preferably from 0 to 10 L/(m²˜h·0.1 MPa). In addition, the tensile strength of these hollow fiber membranes (measurement method described in Examples) is preferably from 4 to 14 MPa.

### EXAMPLES

### (1) Measurement of Pure Water Permeation Amount (Pure Water Permeation Rate) of Hollow Fiber Membrane

One end of the hollow fiber membrane was sealed, and the outer surface area of the hollow fiber membrane excluding the sealing portion was determined. Pressure of P1(=0.1 MPa) was applied from the other end of the hollow fiber membrane to feed pure water and to measure the amount of the pure water passing through the hollow fiber membrane within the measurement time and the internal pressure P2 on the hollow fiber membrane sealing side. From pure water pressure (P1+P2)/2 and the measured value, unit pure water pressure (=0.1 MPa), unit time (=1 h), and the amount of pure water per unit hollow fiber membrane outer surface area (=1 m²) (pure water permeation rate) were calculated.

### (2) Measurement of Tensile Strength of Hollow Fiber Membrane

Hollow fiber membranes in a wet state were clamped one by one with a distance between chucks being 5 cm using a compact tabletop tester (EZ-Test, available from Shimadzu Corporation), and measurement was performed at a tensile speed of 20 mm/min. The tensile strength was determined from the measured value and the cross-sectional area of the hollow fiber membrane.

### Test Example 1 (Hollow Fiber Membrane Chlorine Resistance Test)

In the present test, 50 hollow fiber membranes each from Example 1 and Comparative Example 1 were used (inner diameter/outer diameter=0.8/1.3 mm, length of 1 m). An aqueous solution of sodium hypochlorite with an available chlorine concentration of 12 mass % was diluted with pure water to use the resulting 500 ppm sodium hypochlorite aqueous solution as a test solution. The available chlorine concentration was measured using a Handy Water Meter AQUAB, Model AQ-102, available from Sibata Scientific Technology Ltd. Hollow fiber membranes (50 pieces) were immersed to be completely soaked in the test solution, which is 1 L of the 500 ppm sodium hypochlorite aqueous solution at a liquid temperature of about 25° C., in a plastic container with a lid. In addition, 10 hollow fibers were taken out of the container with a lid every one to three days and washed with tap water, and then moisture was wiped off. The hollow fibers remaining in a wet state was measured for tensile strength.

### Test Example 2 (Measurement of “Tensile Strength” and Judgment Method of Chlorine Resistance)

Hollow fiber membranes in a wet state were clamped one by one with a distance between chucks being 5 cm using a compact tabletop tester (EZ-Test, available from Shimadzu Corporation), and measurement was performed at a tensile speed of 20 mm/min. Based on the value of the “tensile strength” of the hollow fiber membrane not immersed in the 500 ppm sodium hypochlorite aqueous solution as the reference value, the time it took when the tensile strength value of the immersed hollow fiber membrane decreased to below 90% of the reference value was determined. The “tensile strength” of each measurement time was plotted to create a calibration curve and to determine the time it took when the tensile strength decreased to below 90% of the reference value. An average value from 8 pieces after excluding the highest and lowest values of the “tensile strength” measured for 10 pieces from the same sample was determined as the “tensile strength”.

### Example 1

First, 20 mass % of triacetylcellulose (TAC) (acetyl substitution degree of 2.87) available from Daicel Corporation, 16 mass % of sulfolane (good solvent), and 64 mass % of 1,3-butanediol (poor solvent) were heat-dissolved at the temperature indicated in Table 1 (180° C.), and the resulting solution was used as a membrane-forming solution according to an embodiment of the present invention.

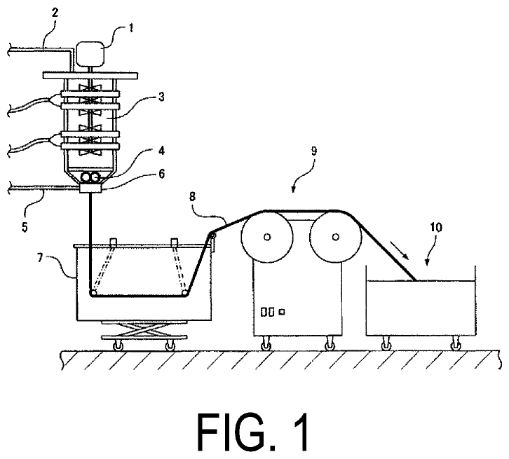

A hollow fiber membrane was produced by a thermally induced phase separation method using the above membrane-forming solution and a manufacturing apparatus of a hollow fiber membrane as illustrated in FIG. 1. Using a metering pump 4 of the apparatus illustrated in FIG. 1, the membrane-forming solution maintained in a dope tank 3 having a capacity of about 500 mL at a discharge temperature indicated in Table 1 (170° C.) was discharged from a double tube nozzle 6, and a core liquid (1,3-butanediol) was discharged from a core liquid line 5. Thereafter, the mixture was guided to a coagulation tank 7 containing 1,3-butanediol at 20° C. and then cooled. Following desolventizing in a washing tank 10 containing water, a hollow fiber membrane was obtained. The resulting hollow fiber membrane had an outer diameter of 1.0 mm and an inner diameter of 0.66 mm.

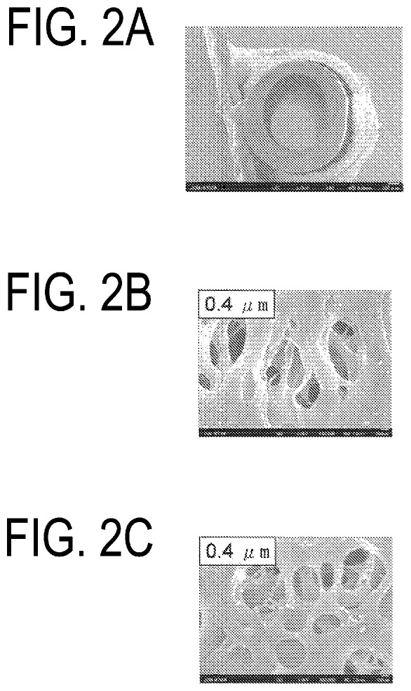

FIGS. 2A to 2C illustrate scanning electron microscope (SEM) (JEOL Ltd.) photographs of the cross-section of the hollow fiber membrane of Example 1. The cross-section of the hollow fiber membrane had a homogeneous sponge structure, and the average pore diameter of voids in the outer surface layer, the inner surface layer and the inner layer was 0.4 μm.

The hollow fiber membrane of Example 1 had a pure water permeation rate of 952 L/(m²·h·0.1 MPa), a tensile strength of 5.3 MPa, and a chlorine resistance of 160 hours.

### Examples 2 to 5

Hollow fiber membranes of Examples 2 to 5 were produced in the same manner as in Example 1 in the spinning conditions indicated in Table 1 using the membrane-forming solutions obtained by heat-dissolving the components indicated in Table 1 at the temperatures listed in Table 1. The pure water permeation amount, the tensile strength and the average pore diameter of each hollow fiber membrane are indicated in Table 2.

### Comparative Example 1

A hollow fiber membrane (inner diameter/outer diameter=0.8/1.3 mm) was produced using the same triacetylcellulose as in Example 1 and using non-solvent phase separation method. As a membrane-forming solution, cellulose triacetate/DMSO=18/82 (mass %) was used. The membrane-forming method was as follows. The membrane-forming solution was sufficiently dissolved at 105° C., and discharged from the outside of the double tube spinneret at a pressure of 0.4 MPa and a discharge temperature of 85° C., and water was discharged from the inner tube as an internal coagulation liquid. Thereafter, the membrane-forming solution was guided to a coagulation water tank containing water, and DMSO was dissolved in the water to coagulate a hollow fiber membrane. The hollow fiber membrane was wound up and obtained.

The resulting hollow fiber membrane was stored in a wet state without drying off the moisture, and measured for pure water permeation amount, tensile strength and chlorine resistance.

The hollow fiber membrane of Comparative Example 1 had a pure water permeation amount of 580 L/(m²·h·0.1 MPa), a tensile strength of 3.8 MPa and a chlorine resistance of 120 hours. FIG. 4 illustrates SEM photographs of the cross-section of the hollow fiber membrane of Comparative Example 1.

TABLE 1

| | Membrane-forming solution composition (mass %) | | | | | Production of hollow fiber membrane | | | |
|---|---|---|---|---|---|---|---|---|---|
| | | | | | Heat | Membrane-forming | | | Coagulation |
| | | | | | dissolution | solution discharge | | | liquid |
| | | | | 2,2-dimethyl- | temperature | temperature | | Coagulation | temperature |
| | TAG | Sulfolane | 1,3-butanediol | 1,3-propanediol | (° C.) | (° C.) | Core liquid | liquid | (° C.) |
| Example 1 | 20 | 16 | 64 | — | 180 | 170 | 1,3-butanediol | 1,3-butanediol | 20 |
| Example 2 | 20 | 16 | 64 | — | 180 | 170 | 1,3-butanediol | 1,3-butanediol/ | 20 |
| | | | | | | | | water = 30/70 | |
| Example 3 | 20 | 16 | — | 64 | 180 | 160 | 1,3-butanediol | 1,3-butanediol | 20 |
| Example 4 | 20 | 16 | — | 64 | 180 | 160 | 1,3-butanediol | Water | 40 |
| Example 5 | 20 | — | 80 | — | 190 | 190 | 1,3-butanediol | Water | 20 |

TABLE 2

| | | | Average pore diameter (μm) | | | Performance | | |
|---|---|---|---|---|---|---|---|---|
| | Membrane size (mm) | | Outer | Inner | | Pure water | Tensile | Chlorine |
| | Inner | Outer | surface | surface | Inner | permeation amount | strength | resistance |
| | diameter | diameter | layer | layer | layer | (L/(m² · h · 0.1 MPa)) | (MPa) | (h) |
| Example 1 | 0.66 | 1.0 | 0.4 | 0.4 | 0.4 | 952 | 5.3 | 160 |
| Example 2 | 0.66 | 1.0 | 0.1 | 0.2 | 0.2 | 804 | 5.7 | — |
| Example 3 | 0.62 | 1.0 | 0.3 | 0.4 | 0 to 0.4 | 83 | 7.2 | — |
| Example 4 | 0.56 | 1.0 | 0 | 0.2 | 0.2 | 5 | 7.0 | — |
| Example 5 | 0.56 | 1.0 | 0 | 0.2 | 0.2 | 0 | 8.0 | — |
| Comparative | 0.8 | 1.3 | 0.02 | 0.1 | 130 μm | 580 | 3.8 | 120 |
| Example 1 | | | | | Macrovoid | | | |
| | | | | | present | | | |

Tables 1 and 2 show that the hollow fiber membranes of Examples had no macrovoid structure in the cross-sectional structure and had a uniform sponge structure with the average pore diameter in a range from 0.01 to 0.4 μm, which was clearly different from the cross-sectional structure of the hollow fiber membrane of Comparative Example 1. From these results, it was confirmed that, in producing a separation membrane by the thermally induced phase separation method using the membrane-forming solution according to an embodiment of the present invention, a selection of a good solvent and a combination of a good solvent and a poor solvent, as well as an adjustment of a heat dissolution temperature and a discharge temperature provide a liquid separation membrane or a gas separation membrane of triacetylcellulose having an acetyl group substitution degree of 2.7 or higher.

### INDUSTRIAL APPLICABILITY

The separation membrane obtained from the membrane-forming solution according to an embodiment of the present invention can be used as a liquid separation membrane, a gas separation membrane and a support membrane or a separation functional membrane that constitutes a liquid separation membrane or a gas separation membrane in various fields, such as a water purification plant, a sewage treatment plant and a gas separation plant.

### REFERENCE SIGNS LIST

1 Stirrer
2 Liquid charging line
3 Dope tank
4 Metering pump
5 Core liquid line
6 Double tube nozzle
7 Coagulation tank
8 Hollow fiber membrane
9 Roller guide
10 Washing tank

1. A membrane-forming solution comprising triacetylcellulose having an acetyl group substitution degree of 2.7 or higher and a good solvent for thermally induced phase separation;
wherein the good solvent is capable of heat-dissolving the triacetylcellulose at a solid content concentration of 25 mass % and is capable of phase-separating the heat-dissolved triacetylcellulose solution while the heat-dissolved triacetylcellulose solution is cooled to room temperature from 20 to 30° C.

2. The membrane-forming solution according to claim 1, wherein the good solvent is one or more selected from 1,3-butanediol, 1,4-butanediol, 1,2-butanediol, 2,3-butanediol and 2,2-dimethyl-1,3-propanediol.

3. A membrane-forming solution comprising triacetylcellulose having an acetyl group substitution degree of 2.7 or higher, a good solvent for thermally induced phase separation and a poor solvent for thermally induced phase separation;
wherein the good solvent is capable of heat-dissolving the triacetylcellulose at a solid content concentration of 25 mass %, and the poor solvent is incapable of dissolving the triacetylcellulose at a solid content concentration of 25 mass % at 160° C.,
both the good solvent and the poor solvent are included so as to enable phase separation of the heat-dissolved triacetylcellulose solution while the heat-dissolved triacetylcellulose solution is cooled to room temperature from 20 to 30° C., and
a mixing ratio in a total amount of the good solvent and the poor solvent is from 5 to 40 mass % of the good solvent and from 60 to 95 mass % of the poor solvent.

4. The membrane-forming solution according to claim 3, wherein the good solvent is selected from sulfolane, dimethyl sulfoxide, tetramethyl urea, tetrahydrofurfuryl alcohol, N-ethyl toluene sulfonamide, triethyl phosphate, trimethyl phosphate and dimethyl succinate.

5. A method for producing a separation membrane using the membrane-forming solution described in claim 1 or 2 to obtain a separation membrane, the separation membrane not having a macrovoid structure but having a uniform sponge structure with an average pore diameter from 0.01 μm to 1 μm, the method comprising:
mixing and heating the triacetylcellulose and the good solvent to obtain the membrane-forming solution,
then, phase-separating the heated membrane-forming solution to form a separation membrane while the heated membrane-forming solution is cooled to room temperature from 20 to 30° C., and
then, washing the separation membrane to remove the good solvent.

6. A method for producing a separation membrane using the membrane-forming solution described in claim 3 or 4 to obtain a separation membrane, the separation membrane not having a macrovoid structure but having a uniform sponge structure with an average pore diameter from 0.01 μm to 1 m, the method comprising:
mixing and heating the triacetylcellulose, the good solvent and the poor solvent to obtain the membrane-forming solution,
then, phase-separating the heated membrane-forming solution to form a separation membrane while the heated membrane-forming solution is cooled to room temperature from 20 to 30° C., and
then, washing the separation membrane to remove the good solvent and the poor solvent.

7. The method for producing a separation membrane according to claim 5, wherein the separation membrane is a hollow fiber membrane, the hollow fiber membrane having a pure water permeation rate from 10 to 3000 L/(m²·h·0.1 MPa) and a tensile strength from 4 to 14 MPa.

8. The method for producing a separation membrane according to claim 6, wherein the separation membrane is a hollow fiber membrane, the hollow fiber membrane having a pure water permeation rate from 10 to 3000 L/(m²·h·0.1 MPa) and a tensile strength from 4 to 14 MPa.
